(19) United States
(12) Patent Application Publication
(10) Pub. No.: US 2008/0007524 A1
(43) Pub. Date: Jan. 10, 2008

(54) Mouse capable of horizontal scrolling

(76) Inventor: Chun-Ching Chang, Banqiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/481,841

(22) Filed: Jul. 7, 2006

(51) Int. Cl. G09G 5/08

(52) U.S. Cl. 345/163

(57) ABSTRACT

A mouse with horizontal scrolling is provided. An auxiliary button is installed besides the basic buttons of the mouse. The auxiliary button can be pressed in coordination with the horizontal movement of the mouse for specific operation. The auxiliary button further cooperates with a function control unit built inside the mouse. When the user activates the auxiliary button and moves the mouse horizontally, the function control unit will activate the scroll lock function and simulate the displacement signal of the mouse such that the cursor displacement mode on the display screen will shift to the document horizontal scrolling mode.

### BACKGROUND OF THE INVENTION

1. Field of the Invention

The present invention relates to a mouse capable of horizontal scrolling, more specifically, the present invention relates to a mouse structure utilizing a single control button (Hotkey) to switch between screen operating modes for increasing the flexibility of manipulation.

2. Description of the Prior Art

A conventional standard mouse generally comprises a left button, a right button, and an intermediate button (some are implemented with a wheel button) for performing various manipulations. Whenever the mouse is moved, the sensor inside the mouse will convert the signal read into an X-Y displacement signal, which is an X-Y cursor mode. In 1996, a wheel mouse technology firstly announced by Microsoft Corporation came with great convenience to computer users and was soon applied in majority mouse products of various mouse manufacturers.

However; for a larger document exceeding the viewable size of the display screen, the present standard wheel mice are only capable of performing a vertically scrolling manipulation and are still failed to perform a horizontal scrolling manipulation.

As a matter of fact, a standard keyboard has already equipped a scroll lock key. The scroll lock key cooperates with arrow keys of the keyboard for controlling the document movement on the display screen. Under normal circumstance, the cursor movement is done by pressing the arrow keys with the document still on the display screen. However, when the scroll lock key is activated, the document will be moved accordingly with the cursor still. This enhances a flexibility of software manipulation. Therefore, the present invention implements the scroll lock function in the mouse, which realizes the document movement on the display screen via the mouse. Besides, with slightly installing an additional button on the original structure, the horizontal scrolling function can be realized without changing the software and hardware system of the computer. Thus, a mouse capable of horizontal scrolling is finally accomplished.

### SUMMARY OF THE INVENTION

An objective of the present invention is to provide a mouse capable of horizontal scrolling, which is able to simulate the scroll lock function of the keyboard for enhancing the flexibility of the manipulation on the display screen.

Another objective of the present invention is to provide a mouse capable of horizontal scrolling, which only slightly adjusts the original mouse structure without substantial changes of the software and hardware system of the computer.

The mouse capable of horizontal scrolling to accomplish the aforementioned objectives is implemented as follows: An auxiliary button is firstly installed besides the basic mouse buttons. As the mouse is moved with the auxiliary button pressed, the effect obtained can be equivalent to the combination of the scroll lock key, the left-arrow key and the right-arrow key. One embodiment is as follows: As the mouse is moved horizontally without auxiliary button pressed, the cursor on the display screen remains horizontal movement. On the other hand; as the mouse is moved horizontally with the auxiliary button pressed, the X-Y cursor mode will shift to the document horizontal scrolling mode. Thus, a horizontal scrolling of a document can be accomplished by directly moving the mouse horizontally.

### BRIEF DESCRIPTION OF THE DRAWINGS

The drawings disclose an illustrative embodiment of the present invention which serves exemplify the various advantages and objects hereof, and are as follows:

FIG. 1 shows a structure perspective drawing of the present invention;

FIG. 2 shows a first operation mode of the present invention;

FIG. 3 shows a second operation mode of the present invention; and

FIG. 4 shows an application flowchart of the present invention.

1 mouse

2 basic buttons

3 auxiliary button

4 function control unit

5 display screen

6 cursor

7 document

### DETAILED DESCRIPTION OF THE PREFERRED EMBODIMENT

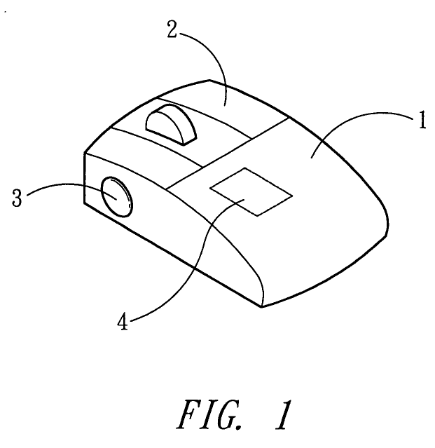

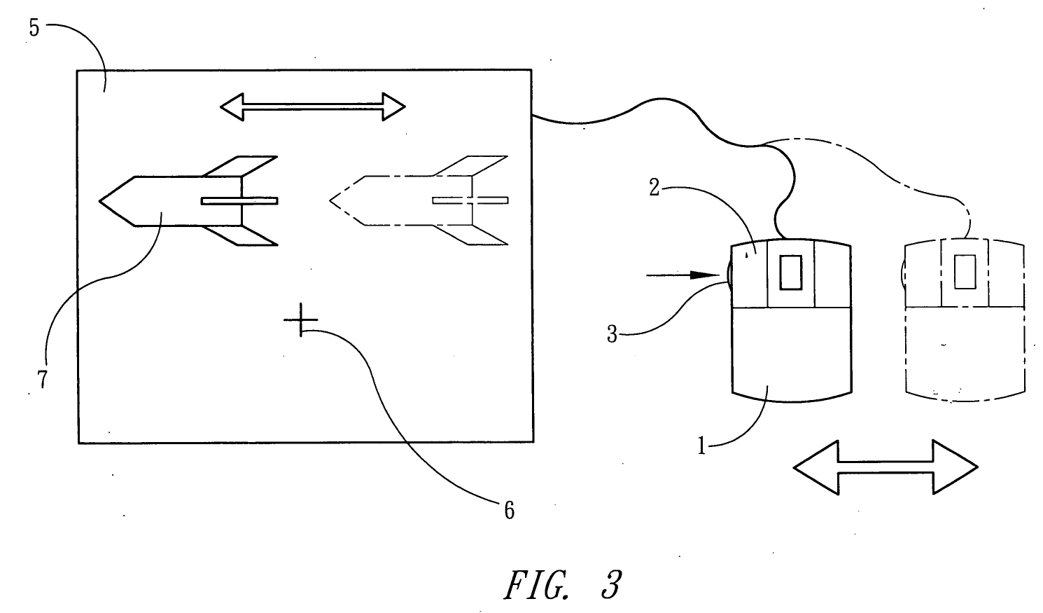

Refer to FIG. 1˜FIG. 3, the mouse capable of horizontal scrolling has a mouse body including basic buttons 2 for the user's fundamental manipulation.

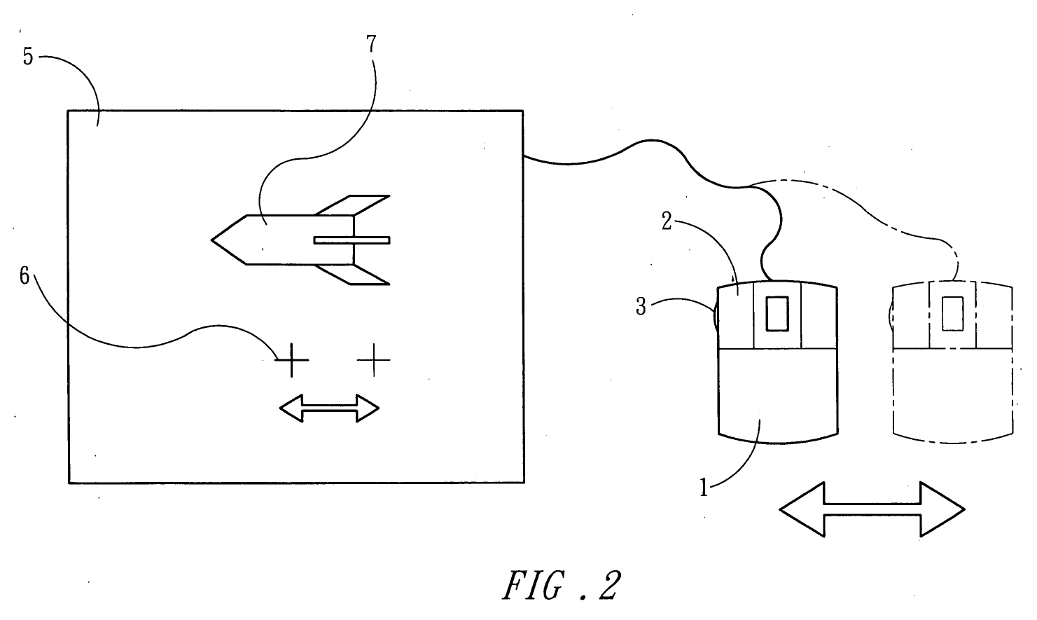

According to the present invention, an auxiliary button 3 is installed besides basic buttons 2 for cooperating with the horizontal movement of the mouse. The auxiliary button 3 is allocated at the surface of the mouse body I where a user's fingers can easily reach. For instance, the auxiliary button 3 is allocated at the left-front side of the mouse body I so that the user can easily press the auxiliary button 3 with his thumb to perform the function. In addition, a function control unit 4 is installed inside the mouse body 1. The function control unit 4 is mainly a microcontroller (MCU), which is signaled by the auxiliary button 3 for operation. As the apparatus described above, a relative position movement of the cursor 6 on the display screen 5 is done when the mouse body 1 is normally moved, as shown in FIG. 2. When the mouse body 1 is moved horizontally with the auxiliary button 3 activated, the function control unit 4 will convert a displacement signal of the cursor 6 into a movement signal of a document 7. The cursor 6 on the display screen 5 remains still with the document 7 being moved instead, as shown in FIG. 3.

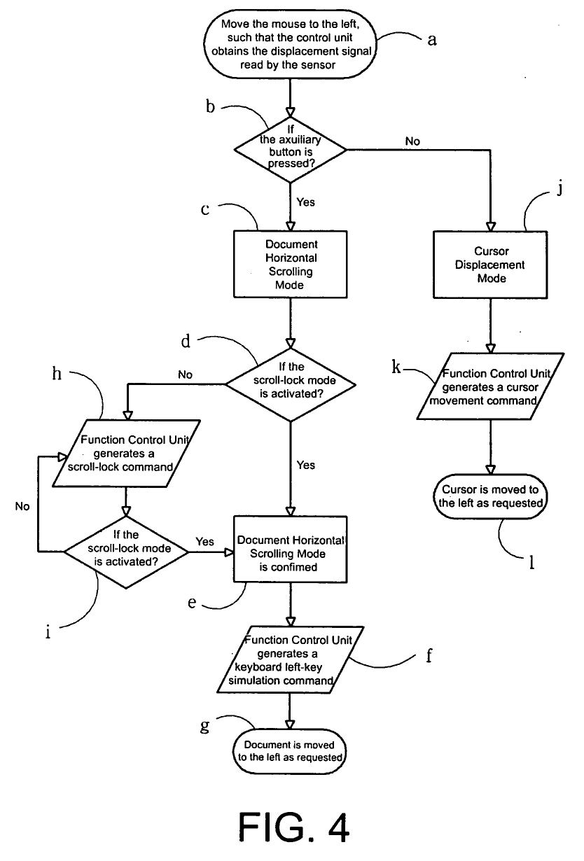

An application flowchart as shown in FIG. 4 illustrates the embodiment described above. To move the document 7 on the display screen 5 to the left comprises the steps of:

(a) The sensor inside the mouse body 1 converts the displacement signal obtained into the electrical signal for the function control unit 4 when the mouse body 1 is moved to the left;

(b) Detecting if the auxiliary button 3 is pressed for determining whether the user intends to shift to the document horizontal scrolling mode of the document 7 from the cursor displacement mode of the cursor 6;

(c) Enter the document horizontal scrolling mode of the document 7 when the auxiliary button 3 is pressed;

(d) Determining if the scroll lock function is activated for confirming if the document horizontal scrolling mode of the document 7 is entered;

(e) If the scroll lock function is activated, then the document horizontal scrolling mode of the document 7 is confirmed;

(f) The function control unit 4 generates a keyboard left-key simulation command;

(g) The document 7 on the display screen 5 is moved to the left;

(h) The function control unit 4 will generate a scroll-lock command if the scroll lock function is not activated in step (d);

(i) Waiting if the scroll lock function is successfully activated. If successful, enter step (e); otherwise, return to step (h) to generate the scroll-lock command again;

(j) Cursor displacement mode is entered when the auxiliary button is not activated;

(k) The function control unit 4 generates a cursor movement command of the cursor 6; and

(l) The cursor 6 on the display screen 5 moves to the left;

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mouse capable of horizontal scrolling, which is characterized in:
an auxiliary button installed on a surface of the mouse besides basic buttons, and a function control unit built inside the mouse, wherein when the mouse is horizontally moved with the auxiliary button activated, a cursor displacement mode on a display screen will shift to a document horizontal scrolling mode.

2. The mouse capable of horizontal scrolling as claimed in claim 1, wherein the function control unit is a microcontroller (MCU).

3. The mouse capable of horizontal scrolling as claimed in claim 1, wherein the auxiliary button is allocated where fingers can easily reach, or the auxiliary button can be a combination of plural buttons.

4. The mouse capable of horizontal scrolling as claimed in claim 1, wherein the function control unit achieves horizontal scrolling by associating with the left/right keys and activating a scroll-lock key on a keyboard.
